(19) United States
(12) Patent Application Publication
(10) Pub. No.: US 2013/0146510 A1
(43) Pub. Date: Jun. 13, 2013

(54) Magnetic Drum Separator with an Electromagnetic Pickup Magnet Having a Core in a Tapered Shape

(71) Applicant: Michael John Ross, Waterford, PA (US)

(72) Inventor: Michael John Ross, Waterford, PA (US)

(21) Appl. No.: 13/462,886

(22) Filed: May 3, 2012

Related U.S. Application Data
(60) Provisional application No. 61/568,991, filed on Dec. 9, 2011.

(51) Int. Cl. B03C 1/14

(52) U.S. Cl. 209/223.2

(57) ABSTRACT

A magnetic drum separator, for separating ferrous and non-ferrous materials from a material stream. The magnetic drum separator comprising an outer shell that is rotatable around a central axis by a drive mechanism. The outer shell having a tubular length parallel to the central axis and a circular cross-section perpendicular to the central axis. An electromagnet pickup magnet positioned at a fixed location within the circular cross-section has a cross-section perpendicular to the central axis. The pickup magnet has a first end closest to the inner circumference of the outer shell and a second ends located near the central axis. The pickup magnet comprises a core, with a backbar abutting it at the second end. The core comprises a plurality of blocks of different widths, in a cross-section perpendicular to the central axis, with the narrowest block at the first end and the widest block abutting the backbar.

### BACKGROUND

Magnetic drum separators are commonly used in recycling, municipal solid waste, wood waste, slag, incinerator bottom ash, foundry sand, and in mineral processing applications. Typically, these magnetic drum separators have a magnetic element that is used to sort material streams that comprise of both ferrous and non-ferrous scrap by extracting the ferrous scrap from the material stream. These magnetic drum separators are typically located immediately downstream of shredders and/or grinders that break up non-ferrous scrap that is not extracted into more manageable pieces for sorting and separating. What is presented is an improved magnetic drum separator for pulling ferrous scrap from a material stream.

### SUMMARY

A magnetic drum separator for the separation of ferrous and non-ferrous materials from a material stream comprising an outer shell that is rotatable around a central axis by a drive mechanism. The outer shell has a tubular length and a circular cross-section. The tubular length is parallel to the central axis and the circular cross-section is perpendicular to the central axis. A pickup magnet that is an electromagnet is positioned at a fixed location within the outer shell, extends along the tubular length, and has a cross-section that is perpendicular to the central axis in which a first end is closest to the inner circumference of the circular cross-section and a second end is located near the central axis. The pickup magnet comprises a core, at least one electrical wire wrapped around the core, and a backbar abutting the core at the second end. The core comprises a plurality of blocks, each block of different widths in a cross-section perpendicular to the central axis. The narrowest of the blocks is at the first end and the widest of the blocks abuts the backbar such that the core has a cross-section perpendicular to the central axis that is an incrementally stepped tapered shape. The pickup magnet is powerful enough to produce a magnetic field suitable for separating ferrous materials from non-ferrous material in the material stream.

Some embodiments of the magnetic drum separator have a carry magnet that is positioned at a fixed location within the outer shell, near the inner circumference of the circular cross-section and downstream of the pick-up magnet in the direction of rotation of the outer shell. Additionally, the magnetic drum separator can have each of the blocks wrapped by at least one electrical wire to form an independent circuit. The magnetic drum separator can also have an interpole magnet positioned at a fixed location between the pickup magnet and the carry magnet. The magnetic drum separator can also have a core that has a cross-section perpendicular to the central axis that is in three step increments. The magnetic drum separator can also have a pickup magnet that further comprises a nosepiece that abuts the core at the first end. The magnetic drum separator could have a core that further comprises a backbar with a cross-section perpendicular to the central axis that is in a stepped shape. The magnetic drum separator could have a core that comprises a single block that has a tapered cross-section perpendicular to the central axis that is narrowest at the first end and widest where the core abuts the backbar.

Other embodiments of the magnetic drum separator have a core that comprises a front block, a middle block, and a back block. Each block has a different width in a cross-section that is perpendicular to the central axis, such that the core has a cross-section perpendicular to the central axis that is an incrementally stepped tapered shape and each block is a different length in the cross-section parallel to the central axis. The front block is the narrowest of the blocks, located at said first end, and is longer than the back block. The back block is the widest of the blocks, abuts against the backbar, and is longer than the middle block.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

### BRIEF DESCRIPTION OF DRAWINGS

For a more complete understanding and appreciation of this invention, and its many advantages, reference will be made to the following detailed description taken in conjunction with the accompanying drawings.

FIG. 1 depicts a magnetic drum separator in operation;

FIG. 2 shows a perspective view of the drum separator FIG. 1;

FIG. 3 depicts a cross-section of a prior art embodiment of a magnetic drum separator in operation;

FIG. 4 shows an overhead cross-section view of the prior art embodiment shown in FIG. 3;

FIG. 5 depicts a cross-section of a different prior art embodiment of a magnetic drum separator in operation;

FIG. 6 is a cross-section view of the preferred embodiment of the magnetic drum separator in operation showing a representation of the generated magnetic field;

FIG. 7 shows a perspective view of the cross-section of the magnetic drum separator of FIG. 6;

FIG. 8 shows a different perspective view of the cross section of the magnetic drum separator of FIG. 6;

FIG. 9 is a perspective cut out view of some of the elements of the inner mechanisms of the magnetic drum separator FIG. 6;

FIG. 10 is a cross-sectional overhead view of the magnetic drum separator of FIG. 6 showing a representation of the generated magnetic field;

FIG. 11 is an exploded view of the magnetic drum separator FIG. 6;

FIG. 12 is a perspective view of the inner mechanisms of an embodiment of the magnetic drum separator having an additional nosepiece element;

FIG. 12A is a forward facing view of the pickup magnet of FIG. 12;

FIG. 13 is a cross-section of the magnetic drum separator of FIG. 12 in operation;

FIG. 14 is a perspective view of FIG. 13;

FIG. 15 is a cross-section of an embodiment of the magnetic drum separator having an additional interpole magnet in operation;

FIG. 16 depicts a perspective view of the inner mechanisms of an embodiment of the magnetic drum separator having an interpole magnet and a rectangular backbar;

FIG. 17 is a cross-section of FIG. 16 in operation and showing a representation of the generated magnetic field;

FIG. 18 is a cross-section of an embodiment of the magnetic drum separator in operation that has a core made of four blocks; and

FIG. 19 is a cross-section of an embodiment of the magnetic drum separator having a core made of a single tapered block.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

What is proposed is a new and improved magnetic drum separator for the separation of ferrous material and non-ferrous materials from a material stream where the internal components of the magnetic drum separator take up less space, weigh less, use less material to manufacture, and are generally more efficient.

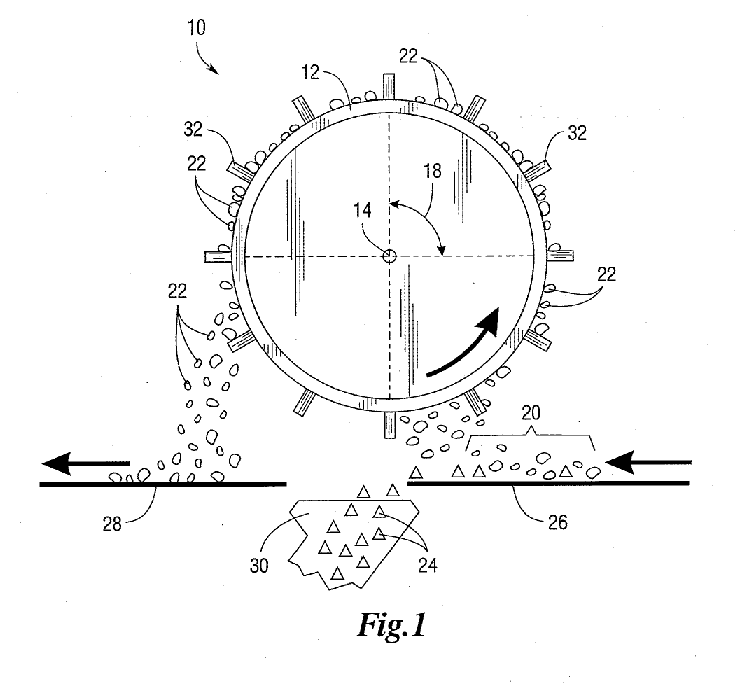

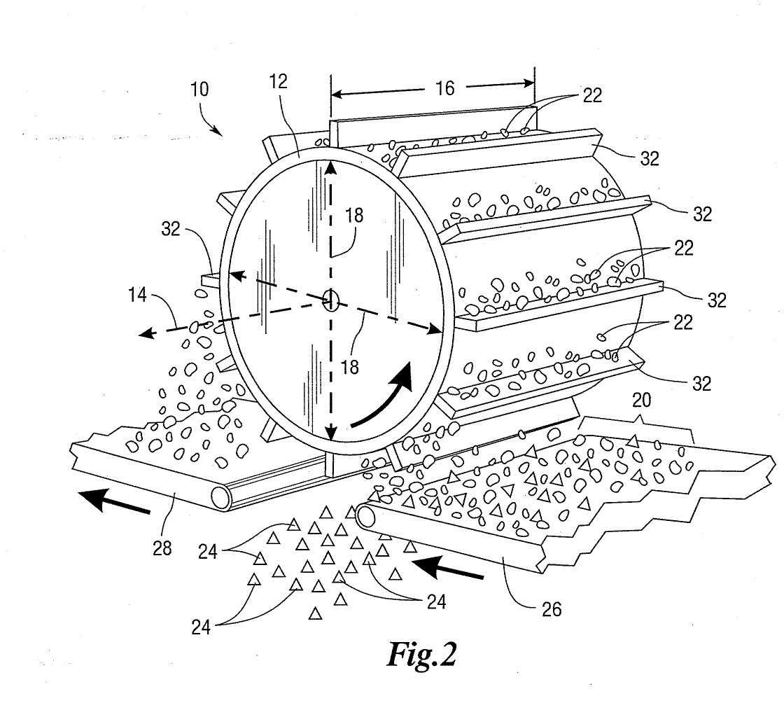

Magnetic drum separator systems typically process several hundred tons of raw materials a day and even several hundred tons per hour depending on the size of the facility and the size of the equipment being used. As shown in FIGS. 1 and 2, magnetic drum separators 10 consist of an outer shell 12 that is rotatable around a central axis 14 by a drive mechanism (not shown) in the direction indicated in the figures and around a number of parts (discussed in more detail later) housed within the outer shell 12. The outer shell 12 has a tubular length 16 and a circular cross section 18 that is centered around the central axis 14. The tubular length is parallel to the central axis 14 and the circular cross-section 18 is perpendicular to the central axis 14. The outer shell 12 is available in a variety of dimensions, but generally the tubular length 16 ranges from 48 to 108 inches and the cross-section 18 can have diameters of 36 to 72 inches.

The material stream 20 to be sorted comprises a mixture of ferrous 22 and non-ferrous 24 materials. The material stream 20 is passed under the drum separator 10 using any appropriate first transfer system 26 such as conveyors, chutes, vibrators, etc. while the outer shell 12 rotates. As will be described later, the ferrous 22 material is magnetically attracted to the drum separator 10 and becomes magnetically attached to the surface of the outer shell 12. As the outer shell 12 rotates, the magnetically attached ferrous 22 material is rotated around the magnetic drum separator 10 until the ferrous 22 material passes out of the magnetic field generated within the magnetic drum separator 10 and falls off the outer shell 12 on the far side of the material stream 20 onto a second transfer system 28. The non-ferrous 24 material of the material stream 20 that is not attracted to the outer shell 12 falls off the first transfer system 26 into a chute 30 or other means for disposal or further processing.

The outer shell 12 of the magnetic drum separator 10 could comprise a series of cleats 32 that assist the movement of the ferrous 22 material on the outer shell 12 of the magnetic drum separator 10.

The internal workings of the magnetic drum separator 10 are at the heart of what makes the system work. Magnetic fields are generated by a series of magnets that are directed towards the first transfer system 26 to pull the ferrous 22 fraction from the material stream 20 and then to hold the ferrous 22 material onto the outer shell 12 as it rotates. The ferrous 22 material is carried around the outer shell 12 and deposited onto the second transfer system 28.

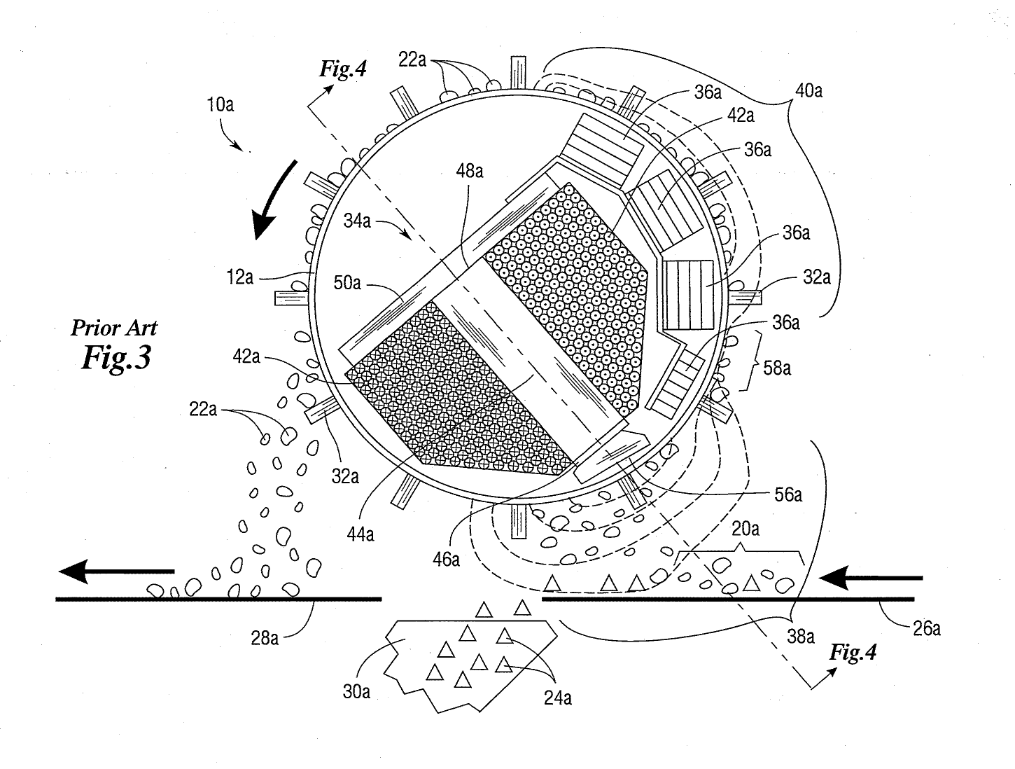

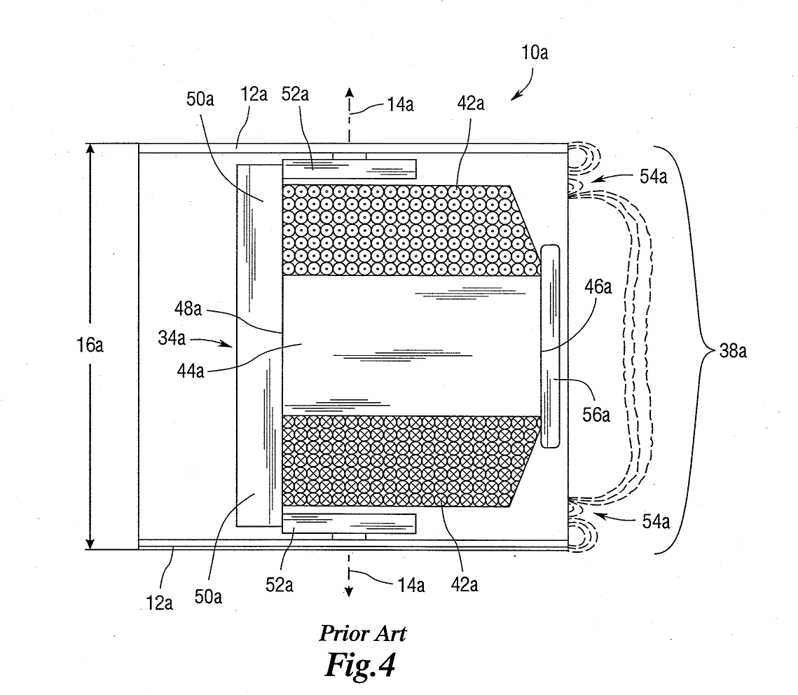

FIGS. 3 and 4 show a prior art magnetic drum separator 10a showing the internal mechanisms used for the separation process. The primary magnet used to separate the ferrous 22a fraction of the material stream 20a from the non-ferrous 24a fraction is called a pickup magnet 34a. Once the ferrous 22a fraction of the material stream 20a is attached to the outer shell 12a, a series of smaller magnets called carry magnets 36a help keep the ferrous 22a material on the outer shell 12a at least until the ferrous 22a material reaches the top of the magnetic drum separator 10a after which there is no further reason to keep the ferrous 22a material on the outer shell 12a and the ferrous 22a material is allowed to drop off by gravity onto the second transfer system 28a.

For purposes of illustration, the magnetic fields generated by the pickup magnet 34a and the carry magnets 36a are depicted as dashed lines emanating from the rotating outer shell 12a. The pickup magnet 34a is positioned and oriented such that the magnetic field 38a it generates is directed towards the material stream 22a on the first transfer system 26a. The carry magnets 36a are positioned above the pickup magnet 34a so that its magnetic field 40a continues to attract the ferrous 22a material to the outer shell 12a.

With some exceptions, the pickup magnets 34a are typically electromagnets which are normally created by wrapping an electrical wire 42a around a core 44a. The core 44a is typically made of some kind of ferrous material. Passing an electrical charge from a power supply (not shown) through the electrical wire 42a creates a magnetic field 38a as depicted by dotted lines in FIG. 3. Through the properties associated with the ferrous core 44a, the passage of electric current through the electrical wire 42a, and around ferrous core 44a, generates a corresponding magnetic field 38a. The electrical wire 42a is typically made of copper or aluminum. The strength of the magnetic field 38a varies with the amount of current passed through the electrical wire 42a, the number of windings that the electrical wire 42a is wrapped around the core 44a, the type of ferrous material that makes up the core 44a, and the size and shape of the core 44a itself.

There is a direct correlation between the number of times electrical wire is wound around a core and the strength of the magnetic field that is generated from an electromagnet. The number of windings versus the strength of the magnetic field can be represented by the following equation:

NI=B₀·g·2.0195−(1+SF)

Where N is the number of windings of the electrical wire, I is the amperage flowing through the electrical wire (NI are measured in “ampere-turns” where turns refers to the number of windings of an electrical wire), B₀ is the flux density of the air gap measured in gauss, g is the air gap measured in inches, and SF is the safety factor. The safety factor is generally added in at 5-10% to ensure a more accurate calculation. This equation is generally used for closed systems that are unlike the open loop systems found in magnetic drum separators. However, the effects of the magnetic fields generated by pickup magnets in magnetic drum separators begin to act like a closed loop system when the ferrous material of the core is magnetically saturated. As can be from the above equation, the flux density, B₀, that is generated is directly related to the number of windings of the electrical wire in that the greater number of windings, the stronger the magnetic field.

An advantage of using electromagnets as pickup magnets 34a is that the magnetic field 38a can be manipulated by controlling the amount of current flowing through the electrical wire 42a. Moreover, the magnetic field 38a can be shut down altogether by turning off the current. This makes cleaning the outer shell 12a simpler and allows for safer routine maintenance when the magnetic drum separator 10a is not in use.

In the prior art embodiment shown in FIGS. 3 and 4, the pickup magnet 34a comprises a single elongated rectangular core 44a with electrical wire 42a wrapped around the core 44a to a thickness of about 12 to 16 inches on each side of the core 44a. The pickup magnet 34a comprises a first end 46a and a second end 48a. The first end 46a is closest to the inner circumference of the circular cross-section 18a and the second end 48a is located closer to the central axis 14a. A backbar 50a abuts against the second end 48a of the pickup magnet 34a. The backbar 50a is typically made from the same ferrous material as the core 44a and provides additional mass to support the entire pickup magnet 34a. The backbar 50a also creates a backstop for the core 44a to push up against and also physically supports the core 44a.

In order to get the pickup magnet 34a as close to the inner circumference of the circular cross-section 18a as possible and within the confines of the outer shell 12a, the pickup magnet 34a is constructed so that fewer wrappings of electrical wire 42a are used around the first end 46a giving the electrical wire 42a a slightly tapered shape. This limitation means that there are fewer windings of the electrical wire 42a around the first end 46a of the core 40a which has a negative effect on the strength of the magnetic field 38a generated by the pickup magnet 34a. Moreover, because of the uneven number of windings across the length of the core 44a, it is common for the electrical wire 42a to unravel during construction when a pickup magnet 34a is inserted into the outer shell 12a.

Furthermore, the pickup magnet 34a has hardware that holds it in place within the magnetic drum separator 12a which takes up additional space. In the embodiment of the prior art shown in FIG. 4, the pickup magnet 34a is mounted to the magnetic drum separator 12a by a pivot point 52a that is typically a weight bearing axle joined to the backbar 50a, configured to position the pickup magnet 34a within the magnetic drum separator 12a. The pivot point 52a runs through the central axis of rotation 14a of the magnetic drum separator 12a.

The orientation of tapered electrical wire 42a in conjunction with the pivot point 52a means that, the pickup magnet 34a does not actually extend across the entire tubular length 16a of the magnetic drum separator 10a. This creates dead zones 54a where the magnetic field 38a generated by the pickup magnet 34a has limited to no effect and that ferrous 22a material within this area will not be attracted to the outer shell 12a. This means that any first transfer system 26a must be sized to fit within this limited magnetic field 42a and represents lost sorting capacity in the entire system.

The second set of magnets in the magnetic drum separator 10a are the carry magnets 36a that are positioned at a fixed location, near the inner circumference of the circular cross-section 18a, and downstream of the pickup magnets 34a in the direction of the rotation of the outer shell 12a. The primary purpose of the carry magnets 36a is to hold the already separated ferrous 22a materials onto the outer surface of the outer shell 12a and therefore they do not have to be as powerful as the pickup magnets 34a. As seen in FIG. 3, the carry magnets 36a do so by extending the magnetic field 40a at least around the arc of the surface of the outer shell 12a in which the ferrous 22a material would be prone to fall back onto the material stream 20a. The carry magnets 34a are typically permanent magnets. Permanent magnets are objects made from material that is magnetized to create a persistent magnetic field that cannot be turned off like the magnetic field of an electromagnet.

The carry magnets 36a are oriented so that the ferrous 22a material extracted from the material stream 20a is able to hold on to the outer shell 12a after the ferrous 22a material has rotated past the portion of the magnetic field 42a generated by the pickup magnet 34a. The location of the carry magnets 36a limits where the pickup magnet 34a can be positioned, forcing either: 1) the pickup magnet 34a being located such that the first end 46a is further away from the inner circumference of the outer shell 12a; or 2) reduce the number of windings of the electrical wire 42a around the core 44a. In either case, the strength of the magnetic field 38a generated by the pickup magnet 34a is hindered which reduces the effectiveness of the magnetic drum separator 10a. In order to reduce the space between the first end 46a and the inner circumference of the circular cross-section 18a, a nosepiece 56a is attached to the core 44a at the first end 46a. This nosepiece 56a pushes the magnetic field 38a strength of the pickup magnet 34a toward the inner circumference of the circular cross-section 18a, but adds to the weight and production costs of the magnetic drum separator 10a.

The space limitations which determine the location of the internal mechanisms of the magnetic drum separator 10a often means that the transition area between the pickup magnet's 34a magnetic field 38a and the carry magnet's 36a magnetic field 40a is somewhat weaker. Areas of weakened magnetic field strength 58a, similar to the one on magnetic drum separator 10a, are generally referred to as a “drop zones.” The magnetic field strength of the drop zone 58a is weak enough such that ferrous 22a material may continuously fall off the surface of the outer shell 12a and get caught again by the pickup magnet's 34a magnetic field 38a. This interaction will continue until the ferrous 20a material is either caught by the pick magnet's 36a magnetic field 40a or the ferrous 22a material falls off the drum separator 10a all together. Ultimately, the drop zone 58a keeps the drum separator 10a from reaching its full potential and leads to waste; costing time and resources; and reducing the overall lower quality drum separator.

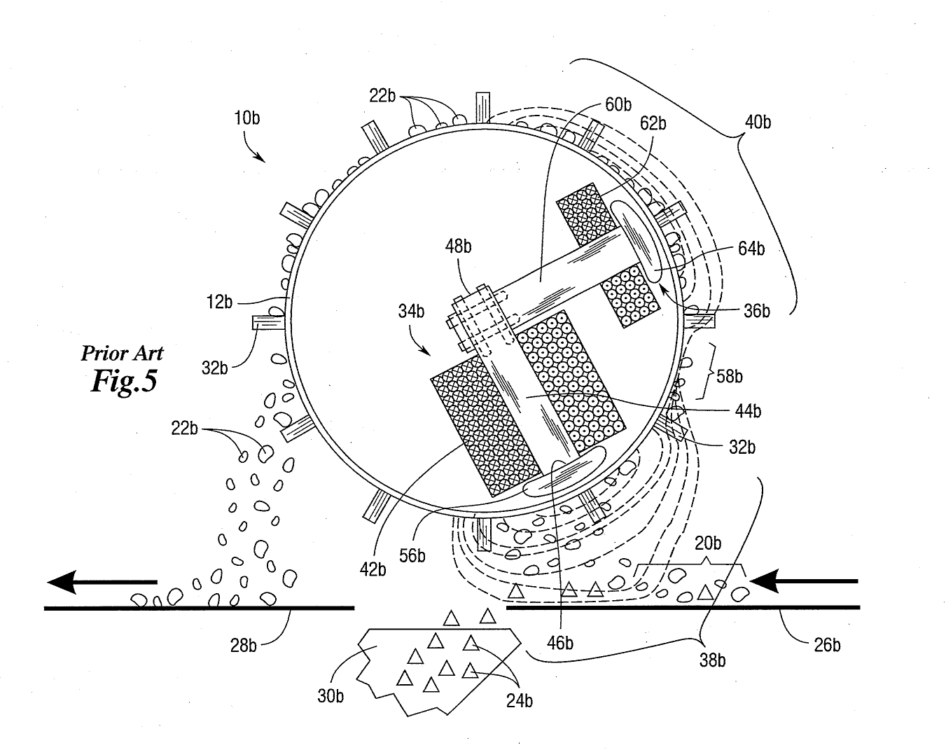

As can be seen in FIG. 5, another prior art embodiment of a magnetic drum separator 10b incorporates a system in which the pickup magnet 34b and carry magnet 36b are both electromagnets. Because of the size and location of the carry magnet 36b, the electrical wire 42b of the pickup magnet 34a does not taper and therefore has a stronger magnetic field closer to the inner circumference of the cross-section 18b. This embodiment also includes a nosepiece 56b on the first end 46b of the core 44b that further extends the magnetic field 38b of the pickup magnet 34b. The carry magnet 36b sits perpendicular to the pickup magnet 34b and comprises a smaller core 60b with electrical wire 62b wrapped around its core 60b. In the embodiment shown in FIG. 5, the carry 36b magnet also has its own nosepiece 64b. As shown above, the strength of the magnetic field of an electromagnet is directly proportional to the number of winding of electrical wire around it. As the pickup magnet 34b must have a stronger magnetic field 38b, its electrical wire 42b is wrapped around its core 44b as much as possible and the carry magnet's 36b electrical wire 62b is only wrapped so that the carry magnet 36b is strong enough to hold ferrous material on the outer shell 12b. This arrangement suffers in that there is a substantial amount of unused space creating a large drop zone 58b, particular to this embodiment, that is between the magnetic field 38b of the pickup magnet 34b and the magnetic field 40b of the carry magnet 36b.

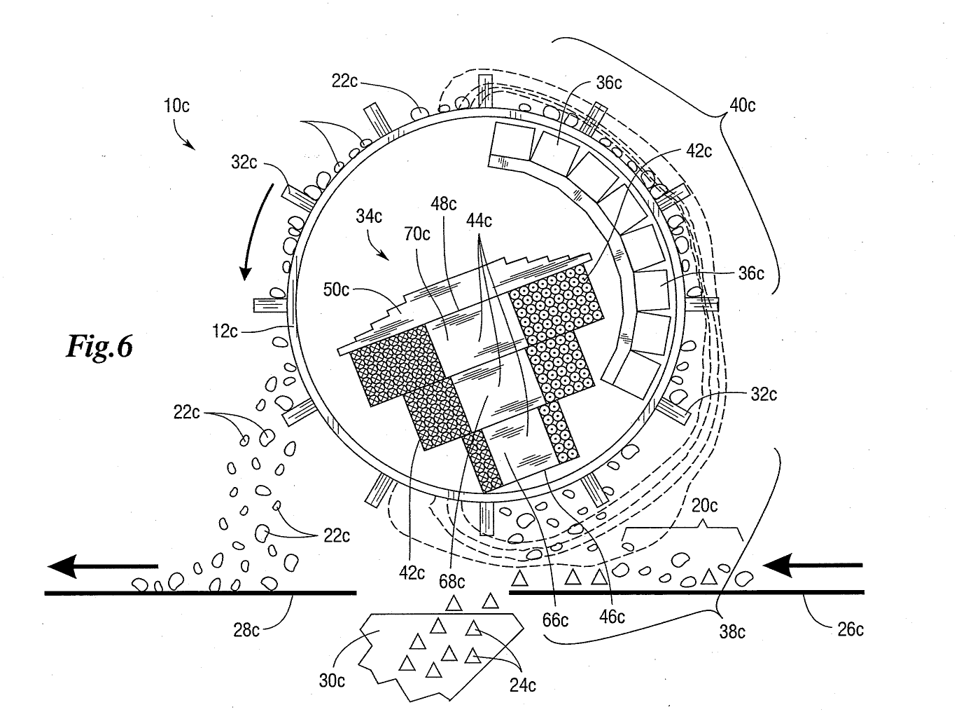

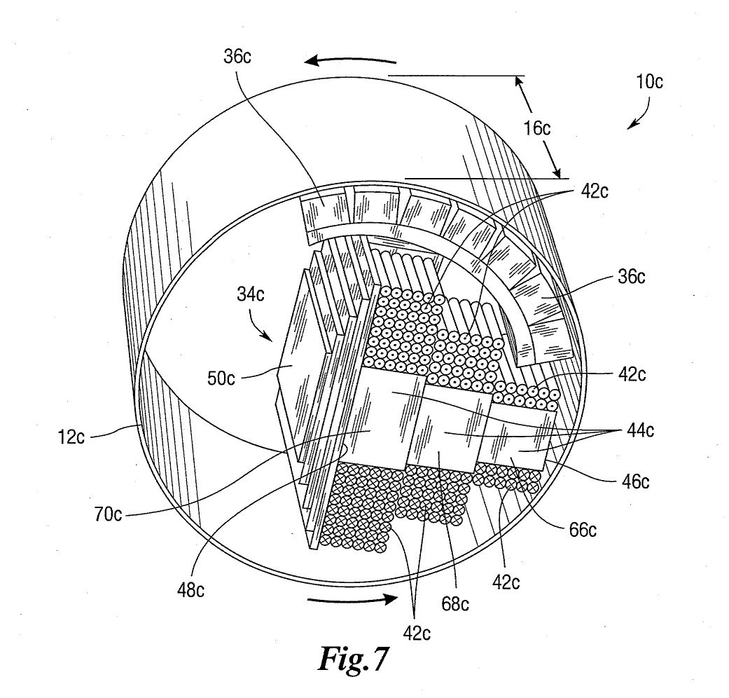

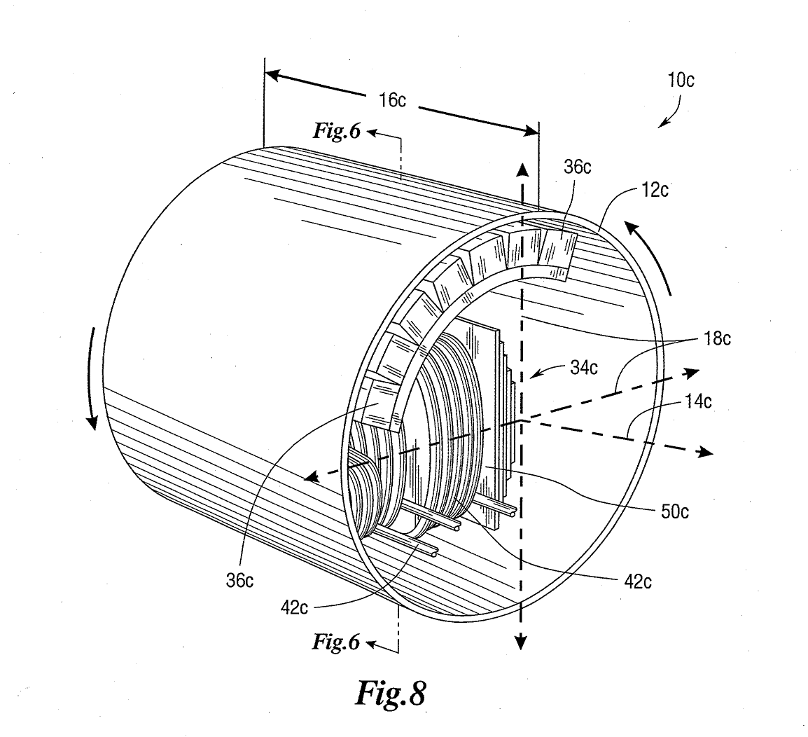

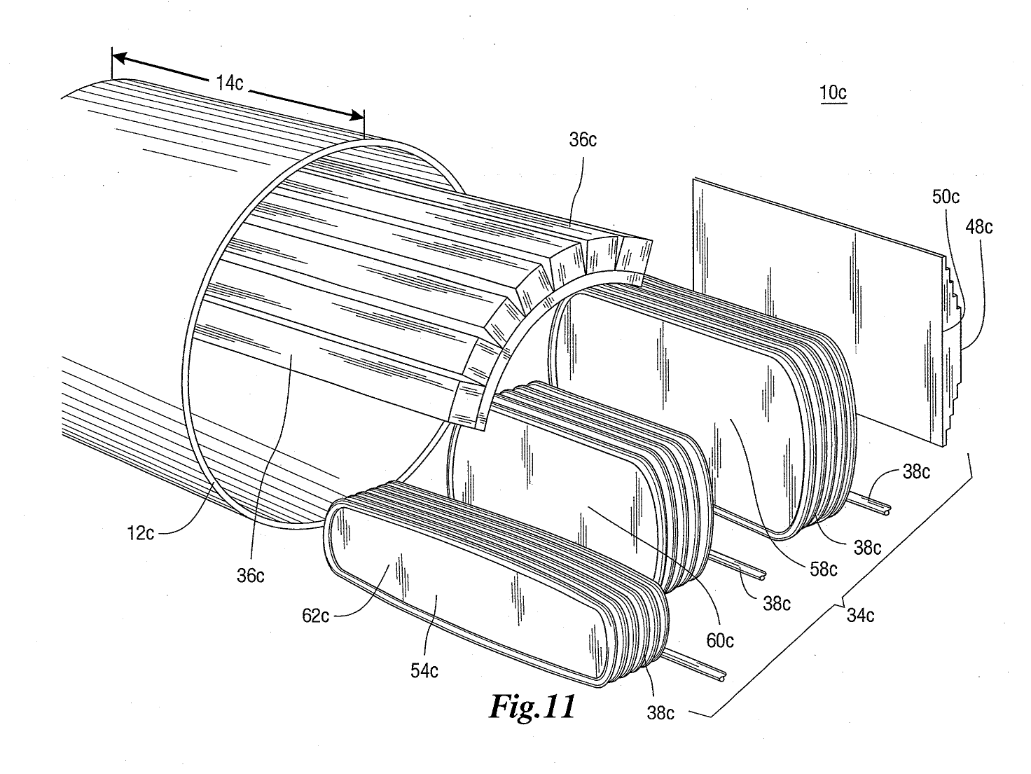

The limitations in the prior art magnetic drum separators are addressed in the preferred embodiment shown in FIGS. 6 through 11. The preferred embodiment comprises an outer shell 12c that is rotatable around a central axis 14c of rotation by a drive mechanism (not shown). The outer shell has a tubular length 16c and a circular cross section 18c. The tubular length 16c is parallel to the central axis 14c and the circular cross-section is perpendicular to the central axis 14c. The outer shell 12c houses the pickup magnet 34c and carry magnets 36c that comprise the magnetic drum separator 10c.

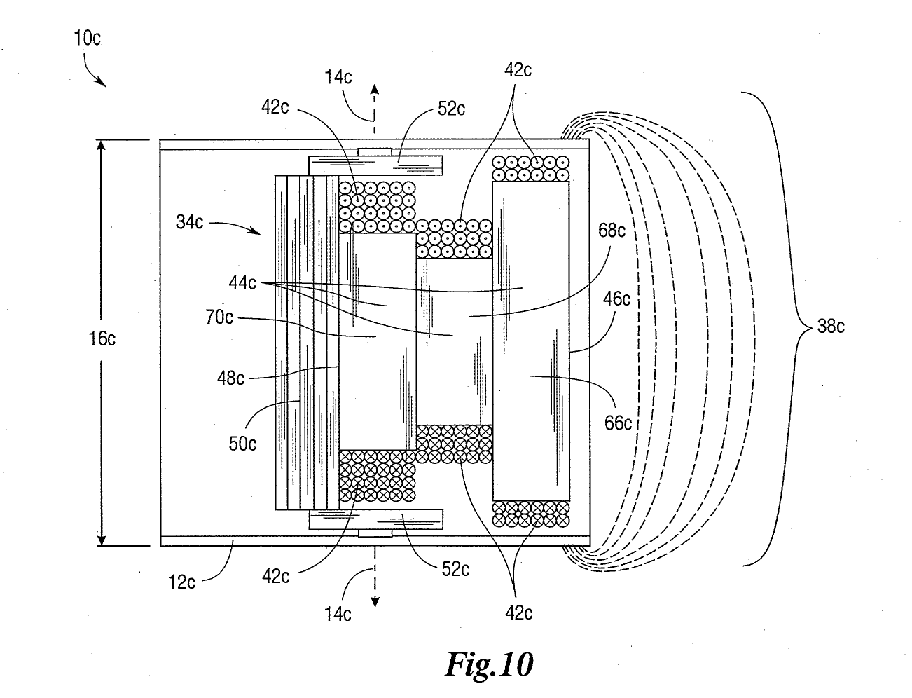

The pickup magnet 34c is an electromagnet that is positioned at a fixed location within the outer shell 12c. The pickup magnet 34c comprises a core 44c, at least one electrical wire 42c wrapped around the core 44c, and a backbar 50c, abutting the core 46c at the second end. The pickup magnet 34c extends along the tubular length 16c of the outer shell 12c and has a cross-section perpendicular to the central axis 14c in which a first end 46c is closest to the inner circumference of the circular cross-section 18c and a second end 56c is located near the central axis 14c. As shown in FIG. 10, the pickup magnet 34c is held in place by a pivot point 52c that is typically a weight bearing axle affixed to the backbar 50c, configured to position the pickup magnet 34c correctly, and runs through the central axis 14c of rotation.

Referring to FIG. 6, since the pickup magnet 34c is the primary sorting tool of the magnetic drum separator 10c, the magnetic field 38c it generates is overall more powerful than the magnetic field 40c that is generated by the carry magnets 36c. The first end 46c of the pickup magnet 34c is the pole from which the magnetic field 38c is generated. The pickup magnet 34c is oriented to point the magnetic field 34c at the material stream 20c on the first transfer system 26c. The pickup magnet 34c is powerful enough to produce a magnetic field 38c suitable for separating ferrous 22c material from non-ferrous 26c material in the material stream 20c.

As seen in FIGS. 6, 7, and 8, the core 44c comprises a front block 66c, a middle block 68c, and a back block 70c. Each block is of different widths in a cross-section perpendicular to the central axis 14c such that the core 44c has a cross-section perpendicular to the central axis 14c that is an incrementally stepped tapered shape. The front block 66c, the middle block 68c, and the back block 70c are each wrapped by an electrical wire 42c to form their own independent circuit.

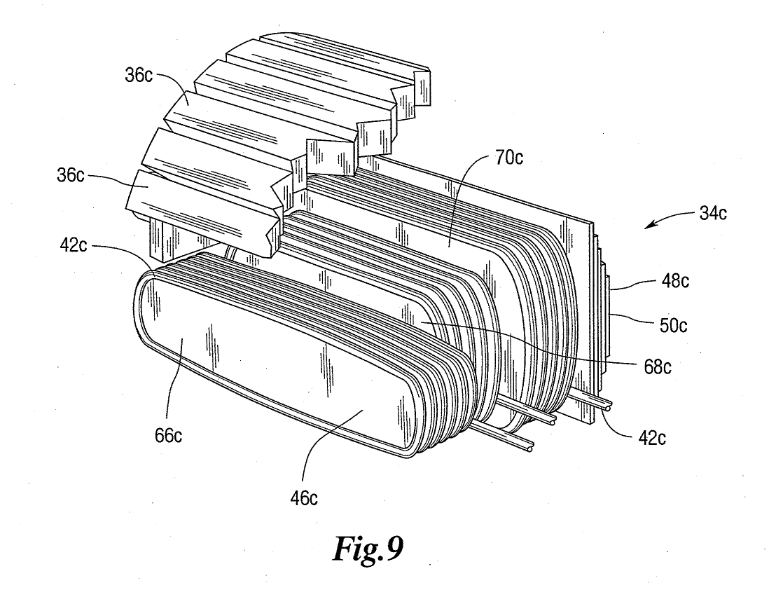

Each block can be individually sized to maximize the available space within the rotating outer shell 12c. As can be seen in FIGS. 9 and 10, the front block 66c, the middle block 68c, and the back block 70c are of a different length in the cross-section parallel to the central axis 14c. The front block 66c is the narrowest of the blocks, located at the first end 46c and is longer than the back block 70c. The back block 70c is the widest of the blocks, abuts against the back bar 50c, and is longer than the middle block 68c. The location of the front block 66c is clear of the pivot point 52c which means that there is more room for a longer block and therefore the front block is sized to make the most use of the available space. In general the front block 66c is longer than the back block. Thus, the combination of the front block 66c and its electrical wire 42c take up as much of the tubular length 16c of the rotating outer shell 12c as possible. The middle block has a length that is shorter than both the lengths of the front block and the back block to save available space within the outer shell 12c as well as an additional benefit of reducing the weight of the pickup magnet 34c.

As can be seen in FIG. 10, this means that the magnetic field 38c created by the pickup magnet 34c in the preferred embodiment extends across the entire tubular length 16c of the outer shell 12c. This eliminates the dead zones along the outer edges of the outer shell seen in the prior art embodiments of magnetic drum separators.

Each of the blocks, the front block 66c, the middle block 68c, and the back block 70c, of the core 44c are made from a metallic ferrous material, such as soft iron or mild steel. In most cases the core 44c will be made from mild steel as opposed to stainless steel because mild steel is more ferrous in content. However, one skilled in the art would see that any ferrous material will be adequate for the core 44c. It may also be feasible to construct the blocks of the core 44c using non-ferrous material or non-metal blocks so long as the pickup magnet 34c is powerful enough to produce a magnetic field 38c suitable for separating ferrous 22c materials from non-ferrous 24c materials in the material stream 20c.

A backbar 50c is located at the second end 48c of the pickup magnet 34c. The backbar 50c is typically made from the same ferrous material as the core 44c and provides an additional mass to support the entire pickup magnet 34c. The backbar 50c also creates a backstop for the back block 70c to push up against which supports the back block 70c in its respective location. The backbar 50c has a cross-section perpendicular to the central axis 14c that is in a stepped shape and abutting the core 44c at the second end 48c. This shape reduces the weight of the backbar 50c as well as the amount of material used in its construction. The backbar 50c also helps to drive the magnetic field 38c perpendicular to the backbar 50c to improve the operating efficiency of the magnetic drum separator 10c.

As can be seen by comparing FIGS. 6, 7, and 8, the tapered shape of the incrementally stepped cross-section of the core 44c maximizes efficient use of the space within the physical limitations of the outer shell 12c. The block configuration of the core 44c allows the number of windings of the electrical wire 42c around each block to be maximized based on the amount of space available to each block individually. In general the shape of the core 44c will allow a greater number of windings than the rectangular core of the prior art. As explained above, the greater number of windings means that the resulting magnetic field 38c created by the core 44c pickup magnet 34c is more powerful than prior art pickup magnets. Moreover, because each block of the core is individually wound with its own electrical wire 42c, it is possible to have each block wound with electrical wire 42c having different diameters. This could further allow for more windings around specific blocks as needed without losing stability in the electrical wire 42c that could cause the electrical wire 42c to unravel.

The stepped core 44c permits the entire pickup magnet 34c to be closer to the inner circumference of the circular cross-section 18c without interfering with the positioning of the other components. With the first end 46c of the pickup magnet 34c closer to the inner circumference of the circular cross-section 18c of the magnetic field 38c generated by the pickup magnet 34c is that much closer (and therefore that much stronger) to the material stream 20c which leads to more efficient separation of ferrous 22c materials from the material stream 20c.

The larger size and location of the back block 70c relative to the other blocks of the pickup magnet 34c requires that more electrical wire 42c be wound around the back block 70c than the other two blocks. These additional windings ensure that the back block 70c adequately contributes to the generation of the magnetic field 38c generated by the pickup magnet 34c. More windings also ensures that the back block 70c produces a magnetic field 38c strong enough to extend from the surface of the outer shell 12c around the locations that are perpendicular to the pickup magnet 34c. Being fundamentally closer to the inner circumference of the circular cross-section 18c, the middle block 68c requires fewer windings to contribute to the generation of an adequate magnetic field 38c. The front block 66c requires even fewer windings than the middle block 68c and the back block 70c.

As shown in FIGS. 6, 7, 8 and 11, the carry magnets 36c are positioned at a fixed location within the outer shell, 12c near the inner circumference of the circular cross-section 18c and downstream of the pick up magnet 34c in the direction rotation of the outer shell 12c. The carry magnets 36c extend along the arc of the inner circumference of the circular cross-section 18c and are oriented so that the ferrous 22c material extracted from the material stream 20c by the pickup magnets 34c is held on to the outer shell 12c after the ferrous 22c material has rotated past the magnetic field 38c that is generated by the pickup magnet 34c. In the preferred embodiment, the carry magnets 36c are permanent magnets and comprise a number of rectangular permanent magnets that extend along the tubular length 16c of the magnetic drum separator 10c. The carry magnets 36c may be a single magnet, series of single magnets, or stacks of magnets arranged to form a desired configuration. However, one skilled in the art would recognize that any type of magnet or configuration of carry magnets 36c could be used to help hold ferrous 22c materials onto the outer shell 12c and carry it away from the material stream 20c. The permanent magnets of the carry magnets 36c may be ceramic, ferrite, or any other appropriate magnetic material. As can be seen in FIG. 6, the arrangement of the pickup magnet 34c relative to the carry magnets 36c in the preferred embodiment means that the magnetic field 38c generated by the pickup magnet 34c more readily overlaps with the magnetic field 40c generated by the carry magnets 36c. This means that the preferred embodiment does not have a drop zone as present in prior art embodiments.

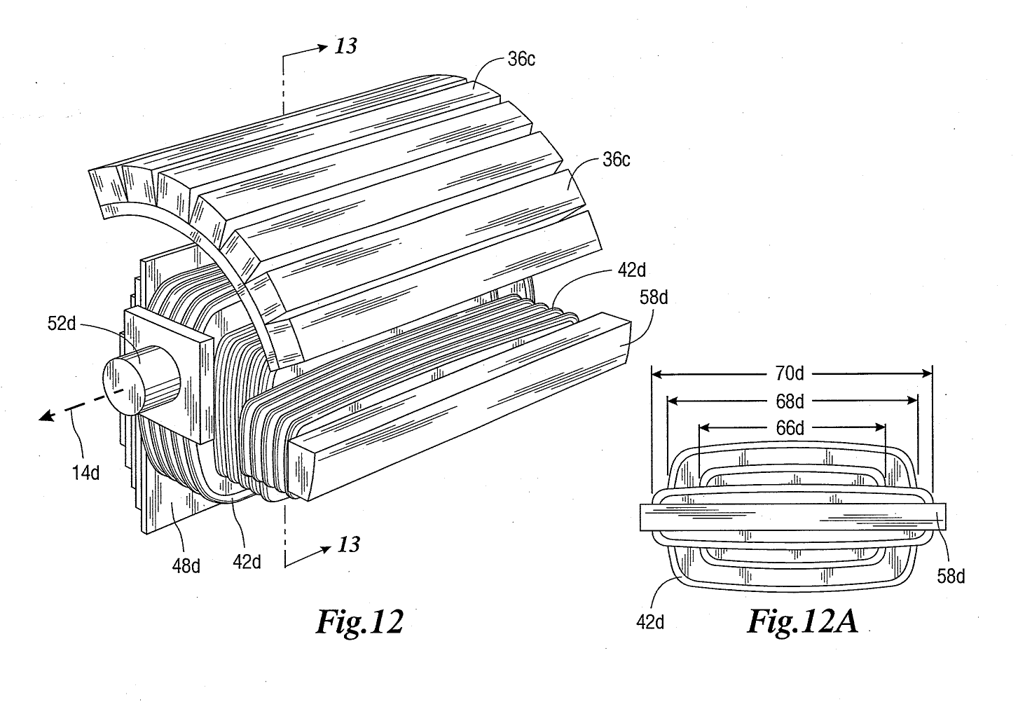

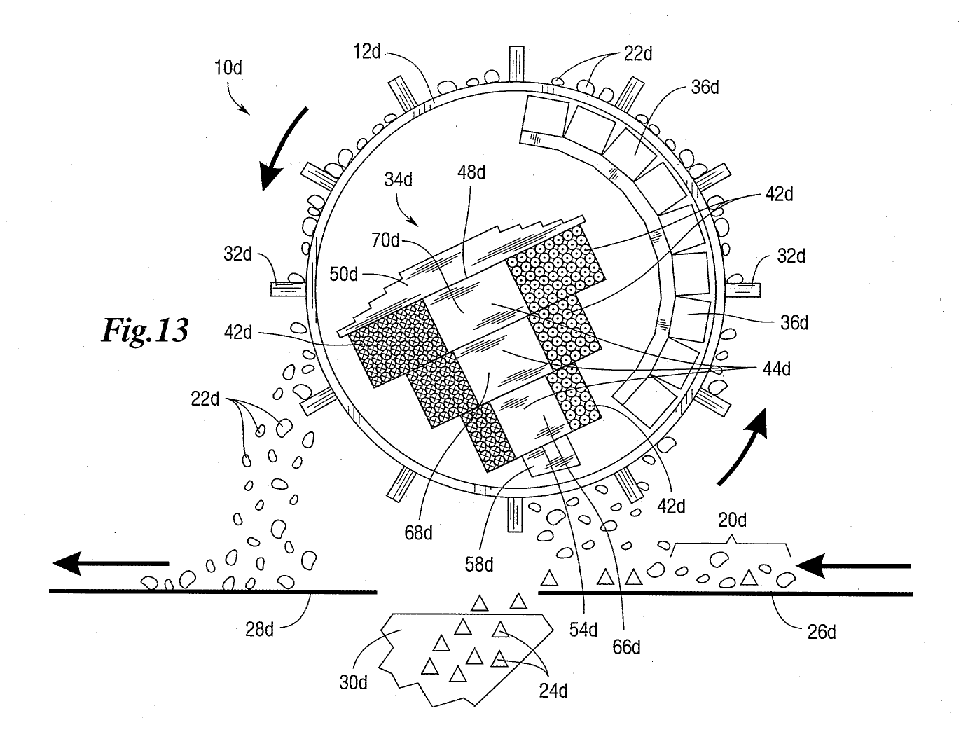

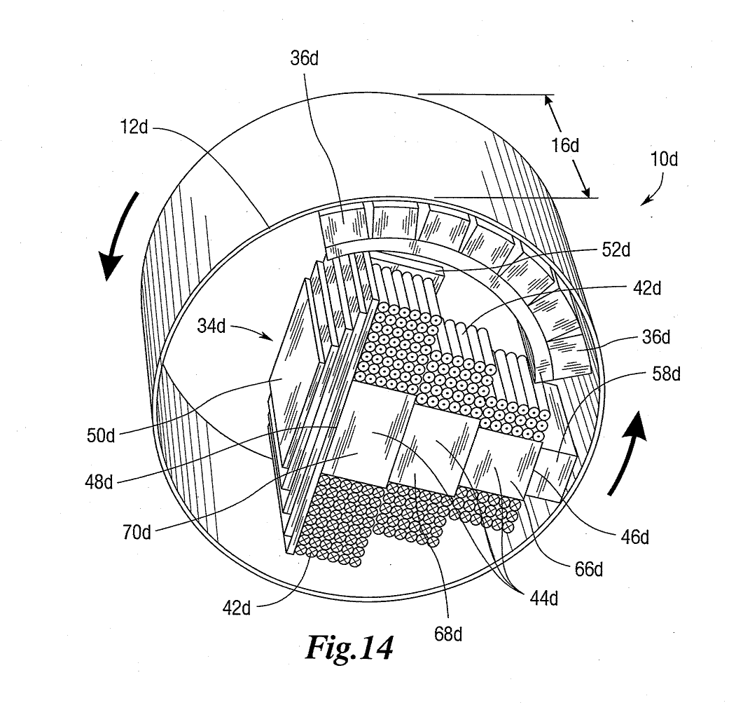

A different embodiment of the magnetic drum separator 10d is shown in FIGS. 12, 12A, 13, and 14. In this embodiment a nosepiece 58d abuts the front block 66d at the first end 46d of the pickup magnet 34d. The nosepiece 58d comprises an unwrapped core element sized to span the tubular length 16d of the outer shell 12d. The nosepiece 58d helps extend the magnetic field 38d generated by the pickup magnet 34d.

FIG. 12A shows the relative length of each block that comprises the core 44a in this embodiment relative to the nosepiece 58d. The length of the middle block 66d is shorter than both the length of the front block 64d and the length of the back block 68d. The back block 68d is the second shortest block because the length of the back block 70d is restricted by the space taken up by the pivot point 52d. The front block 66d spans almost the entire tubular length 14d of the outer shell 12d and the nosepiece 58d spans even further than the front block 66d. FIG. 12A also further illustrates the relative thickness of each of the front block 66d, the middle block 68d, and the back block 70d relative to each other and the nosepiece 58d. Because the nosepiece 58d is not wrapped with electrical wire 42d, it can be positioned even closer to the inner circumference of the circular cross-section 18d which pushes the magnetic field 38d of the pickup magnet 34d even further out from the outer shell 12d.

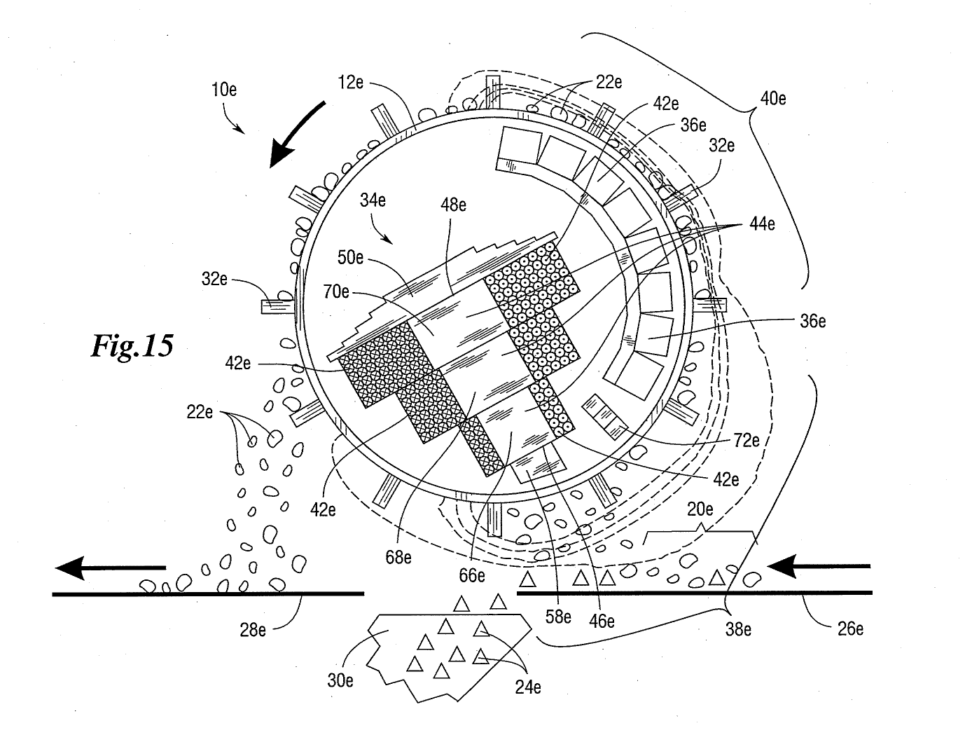

Another embodiment of the magnetic drum separator 10e is shown in FIG. 15, which incorporates an interpole magnet 72e (also known as a bucking magnet) positioned at a fixed location between the pickup magnet 34e and the carry magnets 36e. The interpole magnet 72e is an optional feature that typically comprises a permanent magnet sized to span the across the tubular length 16e of the magnetic drum separator 10e and is positioned along the inner circumference of the circular cross-section 18e. Typically interpole magnets 72e are used in larger diameter magnetic drum separators 10e to help bridge possible drop zone gaps between the magnetic field 38e generated by the pickup magnet 34e and the magnetic field 40e generated by the carry magnets 36e. This embodiment also includes a nosepiece 58e.

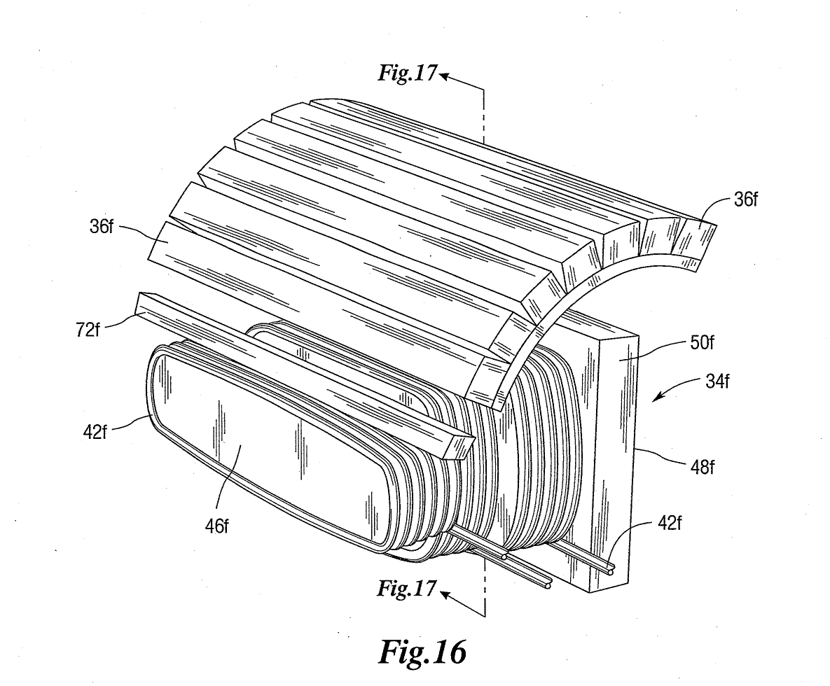

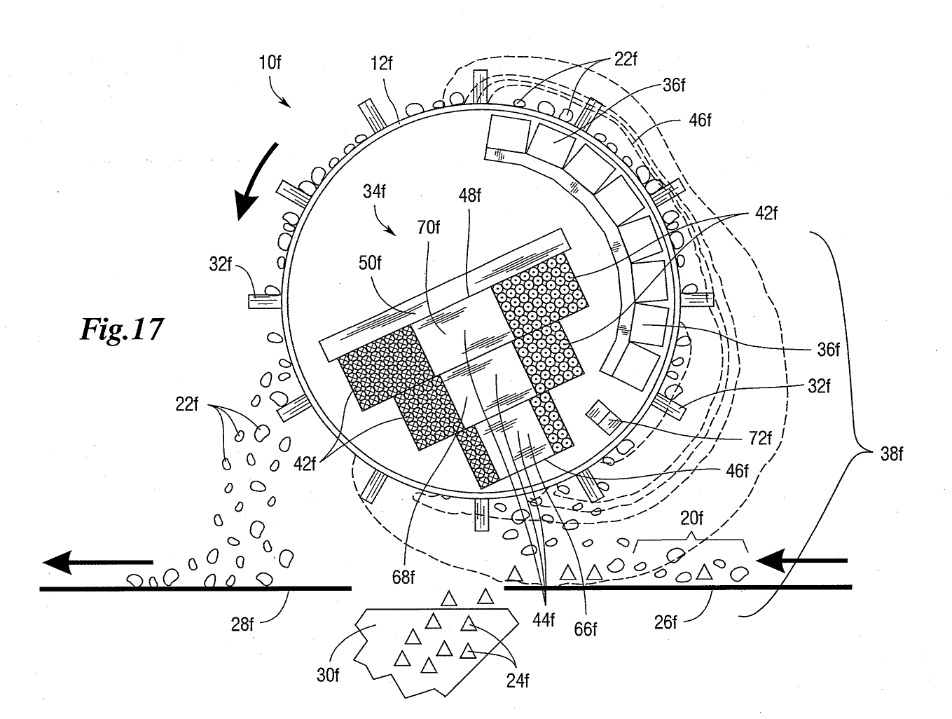

As seen in the embodiment of the magnetic drum separator 10f shown in FIGS. 16 and 17, the magnetic drum separator 10f could not only incorporate an interpole magnet 72f, but also have a rectangular backbar 50f instead of the stepped backbar shown in earlier embodiments. Rectangular backbars 50f operate in substantially the same manner as the stepped backbar of the preferred embodiment, but the rectangular backbar 50f embodiment needs more material to manufacture and are, thus, correspondingly heavier than stepped backbars. Rectangular backbars 50f are less efficient in generating their portion of the magnetic field because of their shape. However rectangular backbars 50f are helpful when used in larger diameter magnetic drum separators 10f because they can support the weight of a much larger pickup magnet 34f than a pickup magnet used in smaller drum separators 10f. These rectangular backbars 50f may add weight and production costs to the magnetic drum separators 10f. It should be noted that there may be specific applications which require magnetic field configurations that call for rectangular backbars 50f as shown and that such situations are well understood by those skilled in the art.

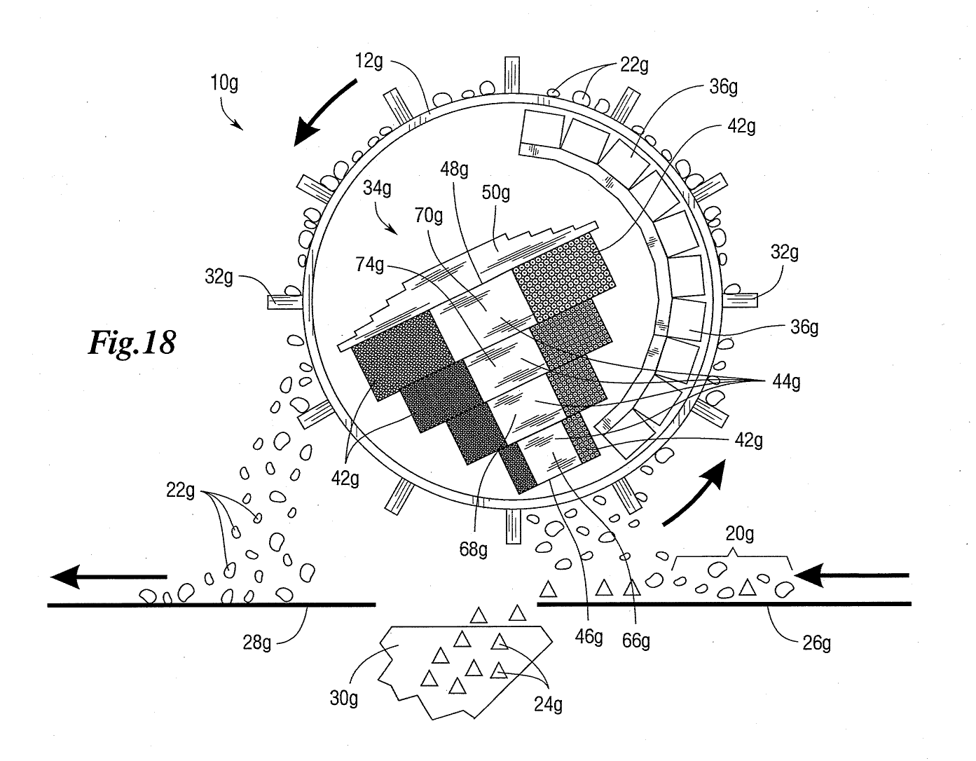

It will be understood that the actual number of blocks comprising the core of the pickup magnet need not be the three shown in the preferred embodiment. For example, in the embodiment shown in FIG. 18, the core 44g of the pickup magnet 34g has an incrementally stepped cross-section perpendicular to the central axis 14g in a tapered shape comprising four blocks: a front block 66g, a first middle block 68g, a second middle block 74g, and a back block 70g. The front block 62g is the narrowest of the four blocks and is located at the first end 46g of the pickup magnet 34g. The back block 70g is the widest of the four blocks and abutts the backbar 50g. Finally, the first middle block 68g and second middle block 74g are incremental in width between the front block 66g and the back block 70g.

Each of the blocks is an independent circuit that has electrical wire 42g wrapped around the block so that the electrical wire 42g only covers a single block and does not overlap any other block. The greater number of blocks creates more surface area for the wire to wrap around that further stabilizes the electrical wire 42g after it has been wrapped around the block and reduces the chances that the electrical wire 42g will come loose and unravel into the outer shell 12g. Thus, the electrical wire 42g used in this embodiment can have a much smaller diameter that may be too unstable for embodiments comprising fewer blocks.

This embodiment allows for the first end 46g of the pickup magnet 34g to be positioned even closer the inner circumference of the circular cross-section 18g than embodiments with fewer blocks. This allows the magnetic field 38g generated by the pickup magnet 34g (not shown) to extend further into the material stream 20g.

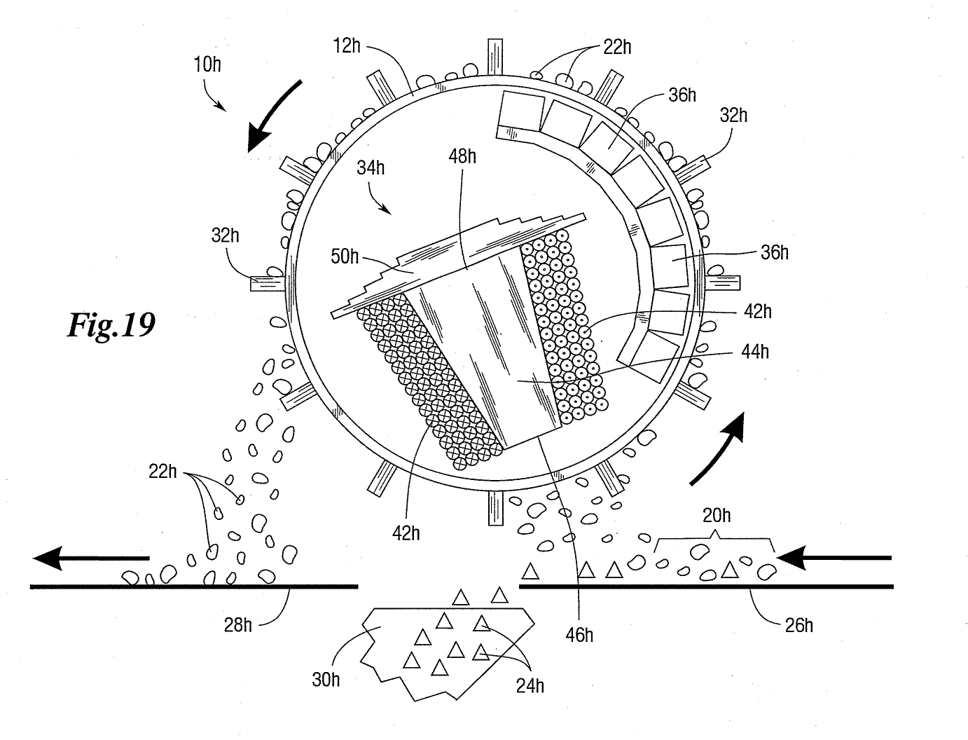

In another embodiment shown in FIG. 19, shows a magnetic drum separator 10h in which the core 44a of the pickup magnet 34g is a single block that has a cross-section that is in a tapered shape. The tapered shape of the core 44h is narrowest at the first end 46h of the pickup magnet 34h and gradually widens until the second end 48h where the core 44h abutts the backbar 50h.

As with the embodiments described earlier, the core 44h is wrapped with an electrical wire 42h. However, unlike the previous embodiments with stepped cores, to construct this embodiment of the magnetic drum separator 10h, the slope of the core 44h demands that the electrical wire 42h must be a larger diameter than that used in the preferred embodiment because the larger diameter electrical wire 42h has more surface area causing friction to make the wire more stable and less likely to slip from position and unravel within the outer shell 12h. Using larger electrical wire 42h means that there can be fewer windings around the core 44h than the preferred embodiment, so the pickup magnet 34h will necessarily generate a weaker magnetic field 38h (not shown).

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A magnetic drum separator for the separation of ferrous and non-ferrous materials from a material stream comprising:
an outer shell that is rotatable around a central axis by a drive mechanism, said outer shell having a tubular length and a circular cross-section centered around said central axis;
said tubular length is parallel to said central axis and said circular cross-section is perpendicular to said central axis;
a pickup magnet that is an electromagnet positioned at a fixed location within said outer shell, extending along said tubular length, and having a cross-section perpendicular to said central axis in which a first end is closest to the inner circumference of said circular cross-section and a second end is located near said central axis;
said pickup magnet comprising a core, at least one electrical wire wrapped around said core, and a backbar abutting said core at said second end;
said core comprising a plurality of blocks, each block of different widths in a cross-section perpendicular to said central axis with the narrowest of said blocks at said first end and the widest of said blocks abutting said backbar such that said core has a cross-section perpendicular to said central axis that is an incrementally stepped tapered shape; and
said pickup magnet powerful enough to produce a magnetic field suitable for separating ferrous materials from non-ferrous materials in the material stream.

2. The magnetic drum separator of claim 1 further comprising a carry magnet positioned at a fixed location within said outer shell, near the inner circumference of said circular cross-section, and downstream of said pick-up magnet in the direction of rotation of said outer shell.

3. The magnetic drum separator of claim 1 further comprising each of said blocks being wrapped by at least one electrical wire to form an independent circuit.

4. The magnetic drum separator of claim 1 further comprising an interpole magnet positioned at a fixed location between said pickup magnet and said carry magnet.

5. The magnetic drum separator of claim 1 in which said core has a cross-section perpendicular to said central axis that is in three step increments.

6. The magnetic drum separator of claim 1 in which said pickup magnet further comprises a nosepiece abutting said core at said first end.

7. The magnetic drum separator of claim 1 in which said core further comprises said backbar having a cross-section perpendicular to said central axis that is in a stepped shape.

8. A magnetic drum separator for the separation of ferrous and non-ferrous materials from a material stream comprising:
an outer shell that is rotatable around a central axis by a drive mechanism, said outer shell having a tubular length and a circular cross-section centered around said central axis;
said tubular length is parallel to said central axis and said circular cross-section is perpendicular to said central axis;
a pickup magnet that is an electromagnet positioned at a fixed location within said outer shell, extending along said tubular length, and having a cross-section perpendicular to said central axis in which a first end is closest to the inner circumference of said circular cross-section and a second end is located near said central axis;
said pickup magnet comprising a core, at least one electrical wire wrapped around said core, and a backbar abutting said core at said second end;
said core comprising a single block having a tapered cross-section perpendicular to said central axis that is narrowest at said first end and widest where said core abuts said backbar; and
said pickup magnet powerful enough to produce a magnetic field suitable for separating ferrous materials from non-ferrous materials in the material stream.

9. The magnetic drum separator of claim 8 further comprising a carry magnet positioned at a fixed location within said outer shell, near the inner circumference of said circular cross-section, and downstream of said pick-up magnet in the direction of rotation of said outer shell.

10. The magnetic drum separator of claim 8 further comprising an interpole magnet positioned at a fixed location between said pickup magnet and said carry magnet.

11. The magnetic drum separator of claim 8 in which said pickup magnet further comprises a nosepiece abutting said core at said first end.

12. The magnetic drum separator of claim 8 in which said core further comprises said backbar having a cross-section perpendicular to said central axis that is in a stepped shape.

13. A magnetic drum separator for the separation of ferrous and non-ferrous materials from a material stream comprising:
an outer shell that is rotatable around a central axis by a drive mechanism, said outer shell having a tubular length and a circular cross-section centered around said central axis;
said tubular length is parallel to said central axis and said circular cross-section is perpendicular to said central axis;
a pickup magnet that is an electromagnet positioned at a fixed location within said outer shell, extending along said tubular length, and having a cross-section perpendicular to said central axis in which a first end is closest to the inner circumference of said circular cross-section and a second end is located near said central axis;
said pickup magnet comprising a core and a backbar;
said core comprising a front block, a middle block, and a back block, each said block of different widths in a cross-section perpendicular to said central axis, such that said core has a cross-section perpendicular to said central axis that is an incrementally stepped tapered shape and each said block of different lengths in the cross-section parallel to the central axis;
said front block is the narrowest of said blocks, located at said first end, and is longer than said back block;
said back block is the widest of said blocks, abuts against said backbar, and is longer than said middle block;
said pickup magnet powerful enough to produce a magnetic field suitable for separating ferrous materials from non-ferrous materials in the material stream.

14. The magnetic drum separator of claim 13 further comprising a carry magnet positioned at a fixed location within said outer shell, near the inner circumference of said circular cross-section, and downstream of said pick-up magnet in the direction of rotation of said outer shell.

15. The magnetic drum separator of claim 13 in which said pickup magnet further comprises a nosepiece abutting said front block.

16. The magnetic drum separator of claim 13 further comprising an interpole magnet positioned at a fixed location between said pickup magnet and said carry magnet.

17. The magnetic drum separator of claim 13 further comprising said front block, said middle block, and said back block each wrapped by an electrical wire to form their own independent circuit.

18. The magnetic drum separator of claim 13 in which said backbar has a cross-section perpendicular to said central axis that is in a stepped shape and abutting said core at said second end.
